(19) United States
(12) Patent Application Publication
(10) Pub. No.: US 2023/0336816 A1
(43) Pub. Date: Oct. 19, 2023

(54) METHOD AND APPARATUS FOR PROCESSING IMAGE USING ALPHA VIDEO DATA

(71) Applicant: KINEMASTER CORPORATION, Seoul (KR)

(72) Inventors: Sung Hyun Ryou, Bucheon-si (KR); June Yong Lee, Seoul (KR)

(21) Appl. No.: 18/301,342

(22) Filed: Apr. 17, 2023

(30) Foreign Application Priority Data
Apr. 18, 2022 (KR) 10-2022-0047329

(51) Int. Cl. H04N 21/4402

(52) U.S. Cl. CPC H04N 21/440281; H04N 21/440272

(57) ABSTRACT

Disclosed herein method and apparatus for processing image using alpha video data. The method includes: receiving color video data and alpha video data through different tracks; decoding each of the color video data and the alpha video data using a predetermined coding method; and generating final color video data in which at least a part of regions is transparently processed, by combining the decoded color video data and the decoded alpha video data.

### CROSS REFERENCE TO RELATED APPLICATION

The present application claims priority to Korean Patent Application No. 10-2022-0047329 filed Apr. 18, 2022, the entire contents of which is incorporated herein for all purposes by this reference.

### BACKGROUND OF THE INVENTION

### 1. Field of the Invention

The present disclosure relates to image processing technology, and more particularly, to a method and apparatus for processing an image using alpha video data.

### 2. Description of the Related Art

In order to draw an image, it is generally composed of three RGB colors. In addition, it may have a value called alpha (α), which represents a transmission ratio for each pixel. This is also called an alpha channel, and has a value from 0 to 255 with 8 bits, ‘0’ being completely transparent and ‘255’ being opaque.

Here, the alpha channel is mainly used when mixing images such as glass windows or glass cups, and gives a transparent effect.

Compression coding refers to a series of signal processing techniques that transmit digitized information through a communication line or store it in a form suitable for a storage medium. Targets of compression coding include voice, image, text, and the like, and in particular, a technique of performing compression coding for an image is called video image compression.

### SUMMARY OF THE INVENTION

An object of the present disclosure is to provide a method and apparatus for processing an image using alpha video data.

An object of the present disclosure is to provide a method and apparatus capable of blending color video data including a transparently processed region generated using alpha video data onto another background image or background video.

According to embodiments of the present disclosure, an image processing method comprises receiving color video data and alpha video data through different tracks, decoding each of the color video data and the alpha video data using a predetermined coding method, and generating final color video data in which at least a part of regions is transparently processed, by combining the decoded color video data and the decoded alpha video data.

In this case, the receiving may comprise receiving the color video data and the alpha video data having the same frame rate.

In this case, the receiving may comprise receiving the color video data and the alpha video data having at least one of different resolutions or aspect ratios.

In this case, the generating the final color video data may comprise, when an aspect ratio of the alpha video data and an aspect ratio of the color video data are different, adjusting an aspect ratio of the decoded alpha video data to an aspect ratio of the decoded color video data, combining the decoded color video data and the decoded alpha video data having the matched aspect ratio, and generating the final color video data.

In this case, the generating the final color video data may comprise, when resolution of the alpha video data and resolution of the color video data are different, adjusting resolution of the decoded alpha video data to resolution of the decoded color video data, combining the decoded color video data and the decoded alpha video data having the matched resolution, and generating the final color video data.

In this case, the receiving may comprise receiving the color video data and the alpha video data having different frame rates.

In this case, the generating may comprise matching a frame rate of the decoded color video data and a frame rate of the decoded alpha video data, combining the decoded color video data and the decoded alpha video data having the matched frame rate, and generating the final color video data.

In this case, the generating may comprise, when a frame rate of the alpha video data is low, interpolating the decoded alpha vide data and matching a frame rate of the decoded color video data and a frame rate of the decoded alpha video data.

Furthermore, the image processing method may further comprise providing video content by combining the final color video data with background image data or background video data selected as a background.

In this case, the providing the video content may comprise providing the video content by overlaying the final color video data in a predetermined region of the background image data or the background video data.

An image processing apparatus according to an embodiment of the present disclosure may comprise a receiver configured to receive color video data and alpha video data through different tracks, a decoder configured to decode each of the color video data and the alpha video data using a predetermined coding method, and a generator configured to generate final color video data in which at least a part of regions is transparently processed, by combining the decoded color video data and the decoded alpha video data.

The features briefly summarized above for this disclosure are only exemplary aspects of the detailed description of the disclosure which follow, and are not intended to limit the scope of the disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an example of explaining an existing image processing technique;

FIG. 2 is a flowchart illustrating a method of processing an image using alpha video data according to an embodiment of the present disclosure;

FIG. 3 is a view illustrating an example of a container structure for explaining the case where frame rates of RGB video data and alpha data video are the same;

FIG. 4 is a flowchart illustrating an embodiment of step S230 of FIG. 3;

FIG. 5 is a flowchart illustrating another embodiment of step S230 of FIG. 3;

FIG. 6 is a view illustrating an example of a container structure for explaining the case where frame rates of RGB video data and alpha video data are different;

FIG. 7 is a flowchart illustrating another embodiment of step S230 of FIG. 3;

FIG. 8 is a view illustrating an example of RGB video data;

FIG. 9 is a view illustrating an example of alpha video data;

FIG. 10 is a view illustrating an example of final RGB video data;

FIG. 11 is a view illustrating an example of a background image;

FIG. 12 is a view illustrating an example for explaining video content provided by a method of the present disclosure;

FIG. 13 is a view illustrating a configuration of an apparatus for processing an image using alpha video data according to another embodiment of the present disclosure; and

FIG. 14 is a view illustrating a configuration of a device to which an image processing device according to another embodiment of the present disclosure is applied.

### DESCRIPTION OF THE PREFERRED EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the tams first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and famed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “ ” at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

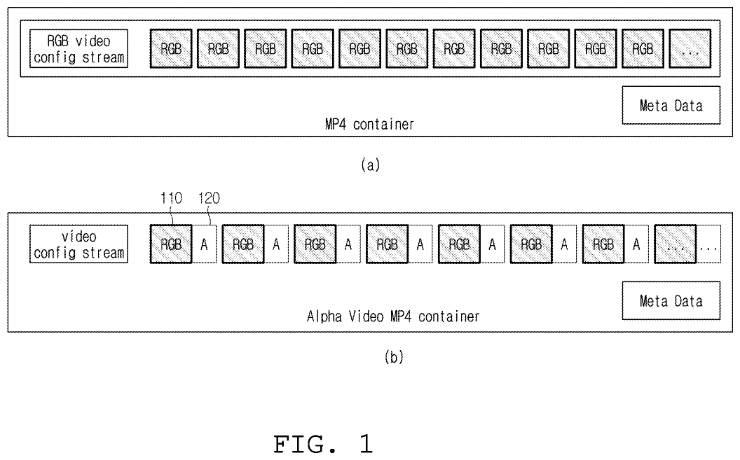

Prior to describing embodiments of the present disclosure, an existing image processing technique will be described with reference to FIG. 1 as follows.

FIG. 1 is a view illustrating an example of explaining an existing image processing technique. FIG. 1A shows an MP4 container structure without an alpha channel, and FIG. 1B shows an alpha video MP4 container structure with an alpha channel.

As shown in FIG. 1A, the MP4 container structure has a structure in which only RGB video data is transmitted at a constant frame rate through one track. In addition, as shown in FIG. 1B, the alpha video MP4 container structure has a structure that requires a High Efficiency Video Coding (HEVC) codec and includes RGB video data 110 and alpha channel data 120 in one track. When an alpha video is implemented with the HEVC codec, since the same config stream is used, the RGB video data 110 and the alpha channel data 120 shall use the same resolution and the same aspect ratio. That is, in the existing alpha video, the size of transmitted data may increase due to the use of the same resolution and aspect ratio, and may require a lot of decoding power.

Content related to such existing alpha video is in the AVC (Advanced Video Coding)/HEVC (High Efficiency Video Coding) codec, and data encoded using the AVC or HEVC codec may be carried and transmitted in an MP4 container. If the codec or the container doesn't support it, the alpha video will not be supported. In other words, even if the specification for storing alpha channel data is added to the MP4 container, existing players or editors that do not support it cannot process it, and similarly, even if the specification for storing alpha channel data is present in the HEVC codec, when the codec installed in the device cannot support it, it will not be processed.

In addition, in order to implement the alpha video, the HEVC codec shall be used. However, when it is difficult to use the HEVC codec in the device, for example, when it is difficult to use the HEVC codec in low-end devices due to problems of resources, it is difficult to implement the alpha video.

The object of the embodiments of the present disclosure is to reduce the size of transmitted data that may be generated in implementing an alpha video in the past and to reduce decoding power required for decoding.

At this time, the embodiments of the present disclosure may use a container including two different tracks, one track includes color video data such as RGB video data or YUV video data, and the other track includes alpha video data (or alpha channel data) for color video data.

In embodiments of the present disclosure, color video data and alpha video data received through respective tracks are decoded using a predefined coding method, and then the decoded color video data and alpha video data are combined or blended, thereby outputting one color video data in which some regions are transparently processed.

In this case, the color video data and the alpha video data may be set to the same frame rate or different frame rates, and may be decoded using the same or different coding methods, such as HEVC, AVC, MP4 or the like. Also, the color video data and the alpha video data may have the same resolution or different resolutions and the same aspect ratio or different aspect ratios. Preferably, in embodiments of the present disclosure, the alpha video data may have resolution lower than that of the color video data, and may have an aspect ratio equal to or different from that of the color video data.

Hereinafter, embodiments of the present disclosure will be described assuming that color video data is RGB video data. Although, in the embodiments of the present disclosure, color video data is described as being limited to RGB video data, color video data is not limited to RGB video data, and may include all kinds of color video data such as YUV color video data.

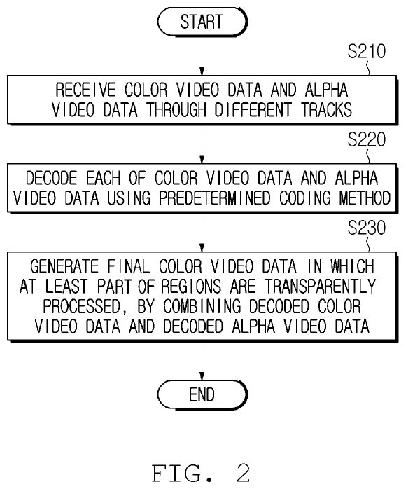

FIG. 2 is a flowchart illustrating a method of processing an image using alpha video data according to an embodiment of the present disclosure.

Referring to FIG. 2, in the method of processing the image using alpha video data according to an embodiment of the present disclosure, RGB video data and alpha video data corresponding to the RGB video data are received through different tracks (S210).

In this case, in step S210, RGB video data encoded by a first coding method, e.g., AVC, and alpha video data encoded by a second coding method, e.g., HEVC, may be received. Of course, the coding method is not limited to AVC and HEVC, and various coding methods such as HEVC, AVC, and MP4 may be applied.

The RGB video data and alpha video data received in step S210 are included and received in two tracks included in one container, and the RGB video data and alpha video data may be received through each of the two tracks of a video container capable of multi-tracking. That is, the embodiments of the present disclosure may be applied to all video containers capable of multi-tracking, and different codec types may be used to distinguish between an RGB video data track and an alpha video data track. For example, RGB video data uses the AVC1 codec and alpha video data uses the other type of codec, so that it is possible to determine which of two tracks of the video container received by an apparatus implementing the method of the present disclosure, for example, an image processing apparatus, is an alpha video data track or an RGB video data track.

In some embodiments, the RGB video data and the alpha video data received in step S210 may be received at the same or different frame rates, may be received with the same resolution or different resolutions, and may be received with the same aspect ratio or different aspect ratios. For example, in step S210, alpha video data having the same frame rate as the RGB video data, a resolution of 1/2, 1/4, or 1/8 of the resolution of the RGB video data, and an aspect ratio different from the aspect ratio of the RGB video data may be received.

Information on the RGB video data and alpha video data transmitted through the two tracks of the video container may be stored in metadata of the video container, and, as the video container metadata, the existing video container metadata may be used without change, a detailed description of which will be omitted.

In addition, RGB video data and alpha video data transmitted through respective tracks may be synchronized by timestamp, and, as the synchronization method, the existing synchronization method may be used without change, a detailed description of which will be omitted.

When RGB video data and alpha video data corresponding to the RGB video data are received through respective tracks in step S210, the RGB video data is decoded using a preset first coding method, and the alpha video data is decoded using a preset second coding method (S220).

Here, in step S220, decoding may be performed using decoding methods corresponding to the encoding methods of the RGB video data and the alpha video data received through respective tracks. According to an embodiment, in step S220, the RGB video data may be decoded through AVC1 and the alpha video data may be decoded through HEVC. According to another embodiment, in step S220, the RGB video data may be decoded through AVC1, and the alpha video data may be decoded through AVC1.

After the decoded RGB video data and the decoded alpha video data are decoded in step S220, the decoded RGB video data and the decoded alpha video data are combined or blended to generate final RGB video data in which at least a part of regions is transparently processed (S230).

In this case, in step S230, if at least one of the frame rates, resolutions or aspect ratios of the decoded RGB video data and the decoded alpha video data do not match, the decoded RGB video data and the decoded alpha video data may be blended after matching at least one of the frame rates, resolutions or aspect ratios, thereby generating final RGB video data. Depending on circumstances, in step S230, even if the frame rates or resolutions are different, the decoded RGB video data and the decoded alpha video data may be blended in a state in which only the aspect ratios are matched without matching the frame rates and the resolutions.

Furthermore, the method according to an embodiment of the present disclosure may provide video content in which the final RGB video data and another color image data or color video data are combined, by overlaying or blending the final RGB video data generated in step S230 in a predetermined region of another color image data or another color video data. That is, since the video content is generated by blending the final RGB video data in which some regions are transparently processed and the color image data or color video data corresponding to a background image or background video, the background image or background video may be displayed without change in the transparently processed region of the final RGB video data. Since such video content can be provided in various forms, they can be applied to various applications. Since such video content may be provided in various forms, it may be applied to various applications. In some embodiments, by combining the final RGB video data generated by the method according to the embodiment of the present disclosure on an image or video stored in a user's smartphone in a frame shape or a moving emoticon shape, it may be applied to an application for generating an image. According to another embodiment, the video content generated by the method according to the embodiment of the present disclosure may also be applied to a messenger application, and a video selected by a user in a conversation message window, for example, fireworks, is generated as final RGB video data and then the conversation message window is set as a background image or background video, thereby providing fireworks to the conversation message window. In addition to this, the method according to the embodiment of the present disclosure may be applied to all types of applications capable of generating content through combination with the background image or background video.

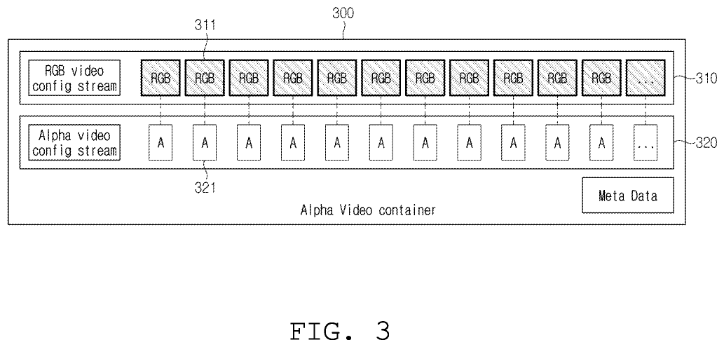

The method according to the embodiment of the present disclosure will be described with reference to FIGS. 3 to 11.

FIG. 3 is a view illustrating an example of a container structure for explaining the case where frame rates of RGB video data and alpha data video are the same.

As shown in FIG. 3, the alpha video container 300 includes RGB video data 311 and alpha video data 321 having the same frame rate in two tracks 310 and 320, respectively. An apparatus for performing an image processing method according to an embodiment of the present disclosure receives the alpha video container 300, decodes the RGB video data 311 included in the first track 310 using a first coding method, for example, AVC1, and decodes the alpha video data 321 included in the second track 320 using a second coding method, for example, HEVC. At this time, the RGB video data 311 and the alpha video data 321 in the two tracks are received at the same frame rate and match 1:1 through time stamps. For example, frames of the tracks may be synchronized one-to-one, so that all RGB video data and all alpha video data may be synchronized.

In the case of FIG. 3, the frame rate is the same, but in order to reduce the amount of transmitted data, at least one of the resolution or aspect ratio of the alpha video data 321 is set to be different from at least one of the resolution or aspect ratio of the RGB video data 311. For example, the resolution of the alpha video data 321 may be set to different resolutions, such as 1/2, 1/4, and 1/8 of the resolution of the RGB video data 311, and furthermore, the alpha video data 321 may have a preset aspect ratio, for example, an aspect ratio of 1:1. For example, the alpha video data 321 may have a size of 256×256.

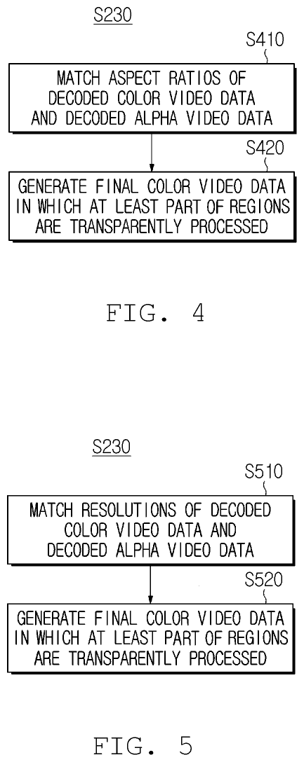

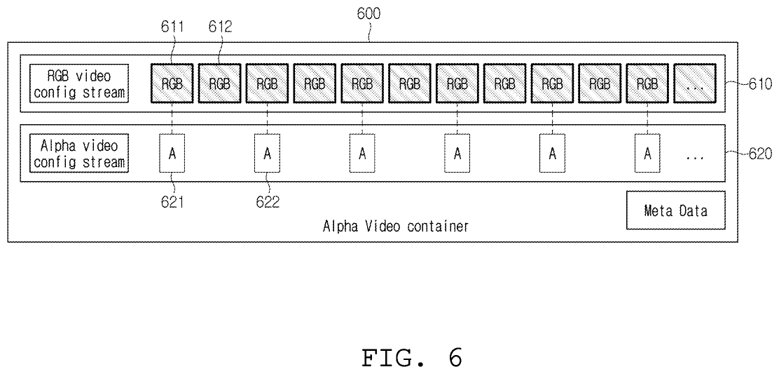

When each of the two tracks is decoded by a preset coding method, final RGB video data may be generated by matching the aspect ratios or resolutions of the two decoded data and then combining the two decoded data. A process of generating final RGB video data will be described with reference to FIGS. 4 and 5 in 1) a case where the aspect ratios of the two data are different and 2) a case where the resolutions are different.

1) When the aspect ratios of the two data are different, as shown in FIG. 4, in step S230 of generating the final RGB video data, final RGB video data in which at least a part of regions is transparently processed may be generated by matching the aspect ratios of the decoded RGB video data and the decoded alpha video data and then blending the two data having the matched aspect ratio (S410 and S420). For example, when the aspect ratio of the RGB video data is 16:9 and the aspect ratio of the alpha video data is 1:1, the aspect ratio of the alpha video data may be adjusted to 16:9. In this case, the resolution of the alpha video data may also be adjusted to the resolution of the RGB video data. In this case, by adjusting the aspect ratio and resolution of the alpha video data, artifacts and the like may occur in a boundary region of the alpha video data and the artifacts may be removed by various existing methods, thereby making the boundary region smooth. The method of removing the artifacts of the boundary region is obvious to those skilled in the art and a detailed description thereof will be omitted.

2) When the resolutions of the two data are different and the aspect ratios thereof are the same, as shown in FIG. 5, in step S230 of generating the final RGB video data, final RGB video data in which at least a part of regions is transparently processed may be generated by matching the resolutions of the decoded RGB video data and the decoded alpha video data and then combining or blending the two data having the matched resolution (S510 and S520). For example, when the resolution of the RGB video data is 1920×1080 and the resolution of the alpha video data is 960×540, since the aspect ratios thereof are equally 16:9, the resolution of the alpha video data may be adjusted to 1920×1080. Even in this case, similarly, artifacts and the like may occur in a boundary region of the alpha video data and the artifacts may be removed by various existing methods, thereby making the boundary region smooth.

Of course, if both the aspect ratio and resolution of the alpha video data are different depending on circumstances, the final RGB video data may be generated by adjusting both the aspect ratio and the resolution to be the same as the resolution and aspect ratio of the RGB video data, and then blending the two data having the same resolution and aspect ratio.

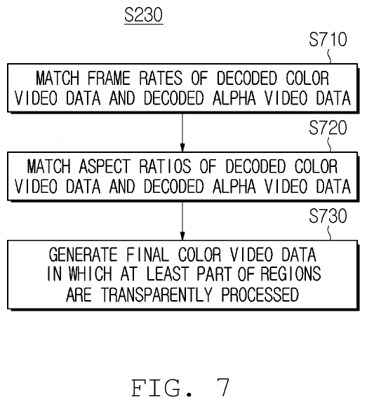

FIG. 6 is a view illustrating an example of a container structure for explaining the case where frame rates of RGB video data and alpha video data are different.

As shown in FIG. 6, an alpha video container 600 includes RGB video data and alpha video data having different frame rates in two tracks 610 and 620, respectively. An apparatus for performing an image processing method according to an embodiment of the present disclosure receives the alpha video container 600, decodes the RGB video data included in the first track 610 using a first coding method, for example, AVC1, and decodes the alpha video data included in the second track 620 using a second coding method, for example, HEVC. At this time, the RGB video data and the alpha video data in the two tracks 610 and 620 are received at different frame rates. For example, the RGB video data is received at a frame rate of 30 and the alpha video data is received at a frame rate of 15. Therefore, two RGB frames match one alpha frame or the frame rate of the alpha video data matches the frame rate of the RGB video data and then the RGB video data and the alpha video data may match 1:1. For example, when the case where two RGB frames match one alpha frame is described with reference to FIG. 6, two RGB frames 611 and 612 may match one alpha frame 621 and this process may be performed on all RGB frames and alpha frames. Since the two RGB frames 611 and 612 match one alpha frame 621, if a region of interest is dynamic, a difference between the region of interest in the second RGB frame 612 and the alpha frame 621 may occur. Accordingly, two RGB frames matching one alpha frame may be preferable when the region of interest is static rather than when the region of interest is dynamic.

On the other hand, a case in which RGB video data and alpha video data match 1:1 after the frame rate of the alpha video data matches the frame rate of RGB video data will be described with reference to FIG. 7.

FIG. 7 is a flowchart illustrating another embodiment of step S230 of FIG. 3, and is a flowchart for explaining the case where frame rates and aspect ratios are different.

As shown in FIG. 7, in step S230 of generating the final RGB video data, the frame rates of the decoded RGB video data and the decoded alpha video data match and then the aspect ratios of the decoded RGB video data and the decoded alpha video data having the matched frame rate match (S710 and S720).

For example, in step S710, when RGB video data is received at a frame rate of 30 and alpha video data is received at a frame rate of 15, the frame rate of the alpha video data may be adjusted to 30. In this case, in step S710, the frame rate of the decoded RGB video data and the frame rate of the decoded alpha video data may match by interpolating the decoded alpha video data. In some embodiments, in step S710, as shown in FIG. 6, by interpolating two alpha frames 621 and 622 to generate an alpha frame for the second RGB frame 612 and performing a process of matching the alpha frame generated by interpolation of the alpha frames 621 and 622 and the second RGB frame 612 on all alpha frames, the frame rate of the RGB video data and the frame rate of the alpha video data may match and the RGB video data and the alpha video data may match 1:1.

In addition, when the frame rates of the RGB video data and the alpha video frame match in steps S710 and S720, final RGB video data in which at least a part of regions is transparently processed by the alpha video data may be generated by combining or blending two data having the matched frame rate and aspect ratio (S730).

Although only matching the aspect ratios after matching the frame rates has been described in FIG. 7, a process of matching the resolutions may be further included if the resolutions are different. Of course, the process of matching the resolutions may be omitted depending on circumstances.

As shown in FIG. 7, matching the frame rate of the alpha video data and the frame rate of the RGB video data and then matching RGB video data and alpha video data 1:1 may be used even when the region of interest is static, but may be more preferably used when the region of interest is dynamic.

As described above, when the frame rates of the RGB video data and the alpha video data are different, since the frame rate of the alpha video data may be lowered, it is possible to reduce the amount of transmitted data and thus to reduce decoding power. In some embodiments, since transmission may be performed by lowering not only the frame rate but also the resolution and aspect ratio of the alpha video data, the amount of data may be further reduced, and decoding power may also be further reduced.

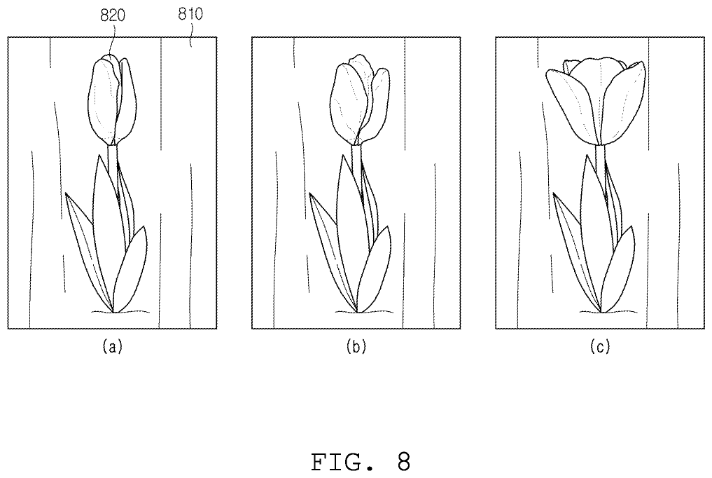

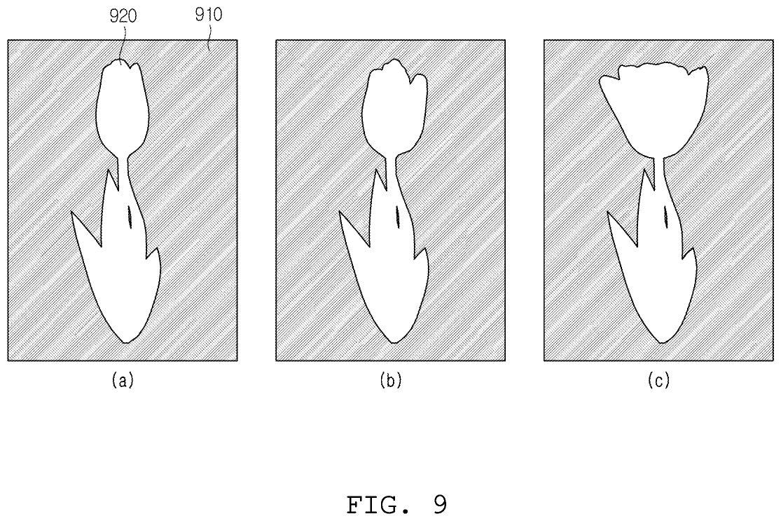

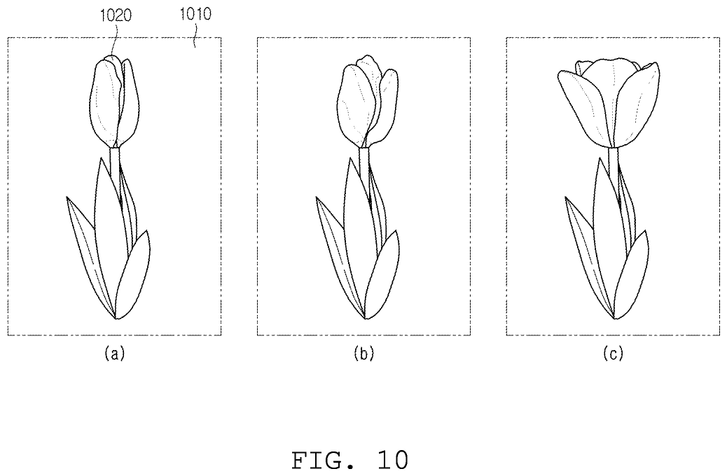

When the final RGB video data in which the remaining region except for the region of interest is transparently processed is generated through the above process, video content desired by a user may be generated by overlaying or blending the final RGB video data generated in this way on a background image or background video selected by the user. For example, when RGB video data (FIGS. 8A to 8C) of blooming a tulip is received through a first track as shown in FIG. 8, and alpha video data (FIGS. 9A to 9C) corresponding to a tulip portion of the RGB video data of blooming the tulip is received through a second track as shown in FIG. 9, final RGB video data (FIGS. 10A to 10C) in which the remaining region except for the region of interest corresponding to the tulip is transparently processed may be generated as shown in FIG. 10, by decoding data received through each track, matching the resolution or aspect ratio of the decoded alpha video data and the resolution or aspect ratio of the RGB video data and then blending the two data.

Here, when the region of interest 820 corresponding to the tulip in the RGB video data of FIG. 8 becomes a region 920 having a value of ‘255’ in the alpha video data of FIG. 9, the remaining region except for the region of interest 820 in the RGB video data of FIG. 8 becomes a region 910 having a value of ‘0’ in the alpha video data of FIG. 9 and data received through two tracks is decoded and then blended by matching the frame rate, the resolution and the aspect ratio, as shown in FIG. 10, final RGB video data in which only a tulip region 1020 corresponding to the region of interest is displayed and the remaining region 1010 is transparently processed is generated.

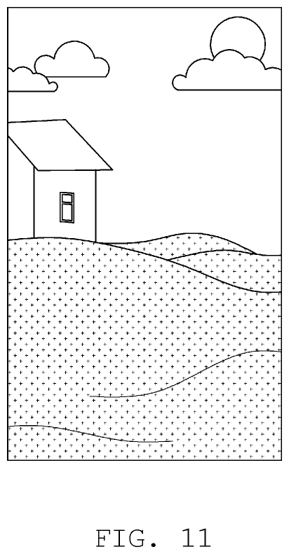

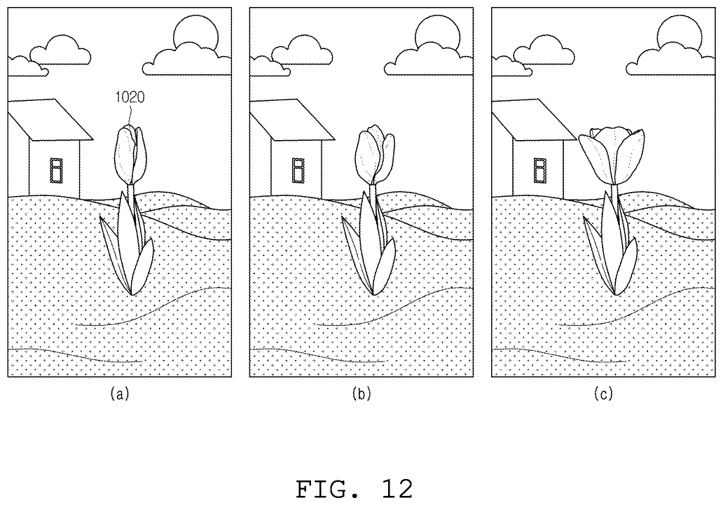

In addition, for the final RGB video data generated in this way, when a background image or video is selected by a user, for example, when the background image of FIG. 11 is selected, video content (FIGS. 12A to 12C) in which the tulip is combined with the background image or video may be generated and provided by overlaying or blending a tulip 1020, in which the remaining region 1010 except for the region of interest of FIG. 10 is transparently processed, on the selected background image or video.

As such, in the image processing method according to an embodiment of the present disclosure, color video data including a transparently processed region generated using alpha video data may be blended onto another background image or video.

In addition, in the image processing method according to an embodiment of the present disclosure, since at least one of the frame rates, resolutions, and aspect ratios of color video data and alpha video data received through two different tracks may be set differently, the amount of encoded data may be reduced, and through this, power consumption and resources of the video codec may be reduced.

In addition, the image processing method according to an embodiment of the present disclosure may be applied to a video service, a messenger service, a photo or video application, and the like in various ways, because color video data in which some regions are transparently processed may be generated.

That is, the image processing method according to the embodiments of the present disclosure may be applied to all devices, because encoded data supported by almost all devices, for example, AVC-encoded data, may be carried and transmitted in a video container supported by almost all devices, for example, an MP4 container.

In addition, when an alpha video is implemented with HEVC, RGB video data and alpha video data use the same resolution. In the other hand, in the embodiments of the present disclosure, since alpha video data may use 1/2, 1/4, 1/8, 1/16, etc. of the resolution of RGB video data, the size of data may be proportionally reduced and the use of encoding power may be reduced. That is, the embodiments of the present disclosure may be applied to various applications by minimizing constraints such as resolution, aspect ratio, and coding method with respect to the alpha video data.

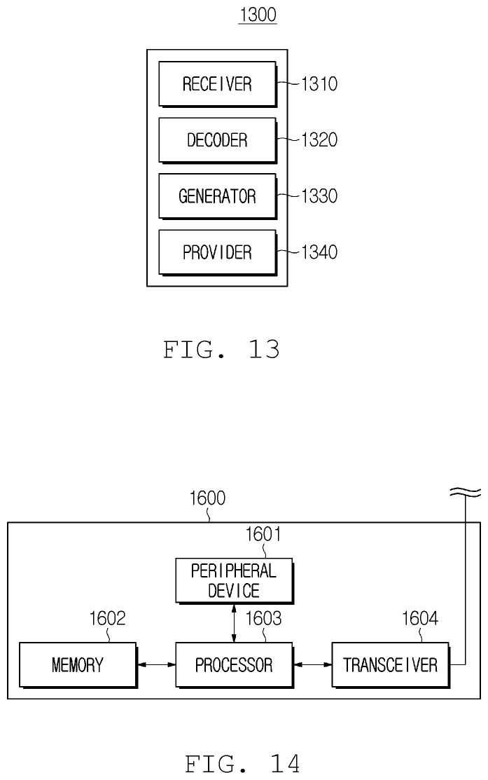

FIG. 13 is a view illustrating a configuration of an apparatus for processing an image using alpha video data according to another embodiment of the present disclosure, and is a view illustrating a configuration of an apparatus for performing the method of FIGS. 2 to 12.

Referring to FIG. 13, an image processing apparatus 1300 using alpha video data according to another embodiment of the present disclosure includes a receiver 1310, a decoder 1320, a generator 1330 and a provider 1340.

The receiver 1310 receives RGB video data and alpha video data corresponding to the RGB video data through two different tracks.

In this case, the receiver 1310 may receive RGB video data and alpha video data encoded using different coding methods through two different tracks, and the two different tracks may be included in a video container.

In some embodiments, the receiver 1310 may receive RGB video data and alpha video data having the same frame rate or different frame rates, receive RGB video data and alpha video data having the same resolution or different resolutions, and receive RGB video data and alpha video data having the same aspect ratio or different aspect ratios. For example, the receiver 1310 may receive 1920×1080 RGB video data and 256×256 alpha video data having the same frame rate.

The decoder 1320 decodes each of the encoded RGB video data and alpha video data received through the receiver 1310 using a predetermined coding method.

In some embodiments, the decoder 1320 may decode the encoded RGB video data using AVC1 and decode the encoded alpha video data using HEVC. Of course, this coding method may be a coding method of encoding RGB video data and alpha video data, and the apparatus according to the embodiment of the present disclosure may perform encoding and decoding using all the available coding methods.

The generator 1330 generates final RGB video data in which at least a part of regions is transparently processed, by combining or blending the RGB video data and alpha video data decoded by the decoder 1320.

In this case, the generator 1330 may generate final RGB video data, by matching at least one of the frame rates, resolutions or aspect ratios and then blending the decoded RGB video data and the decoded alpha video data, when at least one of the frame rates, resolutions or aspect ratios of the decoded RGB video data and the decoded alpha video data do not match.

In an embodiment, when the aspect ratios of the two data are different, the generator 1330 may generate final RGB video data in which at least a part of regions is transparently processed by alpha video data, by matching the aspect ratios of the decoded RGB video data and the decoded alpha video data and then combining or blending the two data having the matched aspect ratio.

In another embodiment, when the resolutions of the two data are different and the aspect ratios thereof are the same, the generator 1330 may generate final RGB video data in which at least a part of regions is transparently processed by alpha video data, by matching the resolutions of the decoded RGB video data and the decoded alpha video data and then combining or blending the two data having the matched resolution.

In another embodiment, when the frame rates and aspect ratios of the two data are different, the generator 1330 may generate final RGB video data in which at least a part of regions is transparently processed by alpha video data, by matching the frame rates of the decoded RGB video data and the decoded alpha video data, matching the aspect ratios of the decoded RGB video data and the decoded alpha video data and then combining or blending the two data having the matched frame data and aspect ratio.

The provider 1340 provides video content in which the final RGB video data and the background image or the background video are combined, by overlaying the final RGB video data generated by the generator 1330 in a predetermined region of a background image or a background video.

Although the description is omitted in the apparatus of FIG. 13, the apparatus according to the embodiment of the present disclosure may include all content described in FIGS. 2 to 12, which is obvious to those skilled in the art.

FIG. 14 is a view illustrating a configuration of a device to which an image processing device according to another embodiment of the present disclosure is applied.

For example, the apparatus for processing the image using alpha video data according to another embodiment of the present disclosure may be the device 1600 of FIG. 14.

Referring to FIG. 14, the device 1600 may include a memory 1602, a processor 1603, a transceiver 1604 and a peripheral device 1601. In addition, for example, the device 1600 may further include another configuration and is not limited to the above-described embodiment.

More specifically, the device 1600 of FIG. 10 may be an exemplary hardware/software architecture such as the image processing apparatus, a video playback device, a content-providing device, a smartphone, a messenger service device, a video-creation device. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600. Also, the processor 1603 may modularly perform the functions of the decoder 1320, the generator 1330 and the provider 1340 of FIG. 13.

Herein, the processor 1603 may execute computer-executable commands stored in the memory 1602 in order to implement various necessary functions of the image processing apparatus using alpha video data. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that image processing apparatus using alpha video data may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

According to an embodiment of the present disclosure, it is possible to provide a method and apparatus for processing an image using alpha video data.

According to an embodiment of the present disclosure, it is possible to blend color video data including a transparently processed region generated using alpha video data onto another background image or background video.

According to an embodiment of the present disclosure, since frame rates, resolutions and aspect ratios of color video data and alpha video data received through two different tracks can be set differently, it is possible to reduce resource of a video codec and to reduce capacity of received video data.

According to an embodiment of the present disclosure, since color video data in which some regions are transparently processed can be generated, it can be applied to video services, messenger services, photo or video applications in various ways.

Effects obtained in the present disclosure are not limited to the above-mentioned effects, and other effects not mentioned above may be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. An image processing method comprising:
receiving color video data and alpha video data through different tracks;
decoding each of the color video data and the alpha video data using a predetermined coding method; and
generating final color video data in which at least a part of regions is transparently processed, by combining the decoded color video data and the decoded alpha video data.

2. The image processing method of claim 1, wherein the receiving comprises receiving the color video data and the alpha video data having the same frame rate.

3. The image processing method of claim 2, wherein the receiving comprises receiving the color video data and the alpha video data having at least one of different resolutions or aspect ratios.

4. The image processing method of claim 3, wherein the generating the final color video data comprises, when an aspect ratio of the alpha video data and an aspect ratio of the color video data are different, adjusting an aspect ratio of the decoded alpha video data to an aspect ratio of the decoded color video data, combining the decoded color video data and the decoded alpha video data having the matched aspect ratio, and generating the final color video data.

5. The image processing method of claim 3, wherein the generating the final color video data comprises, when resolution of the alpha video data and resolution of the color video data are different, adjusting resolution of the decoded alpha video data to resolution of the decoded color video data, combining the decoded color video data and the decoded alpha video data having the matched resolution, and generating the final color video data.

6. The image processing method of claim 1, wherein the receiving comprises receiving the color video data and the alpha video data having different frame rates.

7. The image processing method of claim 6, wherein the generating comprises matching a frame rate of the decoded color video data and a frame rate of the decoded alpha video data, combining the decoded color video data and the decoded alpha video data having the matched frame rate, and generating the final color video data.

8. The image processing method of claim 7, wherein the generating comprises, when a frame rate of the alpha video data is low, interpolating the decoded alpha vide data and matching a frame rate of the decoded color video data and a frame rate of the decoded alpha video data.

9. The image processing method of claim 1, further comprising providing video content by combining the final color video data with background image data or background video data selected as a background.

10. The image processing method of claim 9, wherein the providing the video content comprises providing the video content by overlaying the final color video data in a predetermined region of the background image data or the background video data.

11. An image processing apparatus comprising:
a receiver configured to receive color video data and alpha video data through different tracks;
a decoder configured to decode each of the color video data and the alpha video data using a predetermined coding method; and
a generator configured to generate final color video data in which at least a part of regions is transparently processed, by combining the decoded color video data and the decoded alpha video data.

12. The image processing apparatus of claim 11, wherein the receiver receives the color video data and the alpha video data having the same frame rate.

13. The image processing apparatus of claim 12, wherein the receiver receives the color video data and the alpha video data having at least one of different resolutions or aspect ratios.

14. The image processing apparatus of claim 13, wherein, when an aspect ratio of the alpha video data and an aspect ratio of the color video data are different, the generator adjusts an aspect ratio of the decoded alpha video data to an aspect ratio of the decoded color video data, combines the decoded color video data and the decoded alpha video data having the matched aspect ratio, and generates the final color video data.

15. The image processing apparatus of claim 13, wherein, when resolution of the alpha video data and resolution of the color video data are different, the generator adjusts resolution of the decoded alpha video data to resolution of the decoded color video data, combines the decoded color video data and the decoded alpha video data having the matched resolution, and generates the final color video data.

16. The image processing apparatus of claim 11, wherein the receiver receives the color video data and the alpha video data having different frame rates.

17. The image processing apparatus of claim 16, wherein the generator matches a frame rate of the decoded color video data and a frame rate of the decoded alpha video data, combines the decoded color video data and the decoded alpha video data having the matched frame rate, and generates the final color video data.

18. The image processing apparatus of claim 17, wherein, when a frame rate of the alpha video data is low, the generator interpolates the decoded alpha vide data and matches a frame rate of the decoded color video data and a frame rate of the decoded alpha video data.

19. The image processing apparatus of claim 11, further comprising a provider configured to provide video content by combining the final color video data with background image data or background video data selected as a background.

20. The image processing apparatus of claim 19, wherein the provider provides the video content by overlaying the final color video data in a predetermined region of the background image data or the background video data.
